(19) United States
(12) Patent Application Publication
(10) Pub. No.: US 2004/0015250 A1
(43) Pub. Date: Jan. 22, 2004

(54) Computer system with a plurality of audio and video output devices

(76) Inventor: Yong-Nam Kim, Seongnam-city (KR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/332,938

(22) PCT Filed: Jul. 13, 2001
(86) PCT No.: PCT/KR01/01210

(30) Foreign Application Priority Data
Jul. 14, 2000 (KR) 2000/40706

(51) Int. Cl. G06F 17/00

(52) U.S. Cl. 700/94

(57) ABSTRACT

A computer system comprises a plurality of a graphic data output units for displaying the graphic data to a user, a plurality of graphic data processors for analyzing the graphic data and converting them into data that fit the graphic data processors' output-formats; a first graphic data controller for receiving the graphic data, setting a graphic data processor according to control signals, and providing the corresponding graphic data to the set graphic data processor; a control signal input unit for generating the control signals for setting by what graphic data processor the corresponding graphic data are to be processed; an application program storage unit for storing application programs; and a CPU for driving the application programs, receiving graphic data generated when driving the application programs, receiving the control signals from the control signal input unit, and outputting the graphic data and the control signals to the graphic data controller.

### BACKGROUND OF THE INVENTION

(a) Field of the Invention

The present invention relates to a system having audio and video output devices. More specifically, the present invention relates to a computer with a plurality of audio and video output devices

(b) Description of the Related Art

As the consumer electronics field has developed, modern people have come to see various electronic products such as TVs, radios, audio devices and digital video disks (DVDs). In particular, developments of computers have made it possible to manage these electronic products as a single system.

However, in order to integrate the various electronic products into a single system, a controller for controlling output of sound data or graphic data of these electronic products is required. Also, since a huge volume of data must be processed to drive a DVD driver that supports high-resolution image quality and hi-fi sound, a heavy load is imposed on a central processing unit (CPU) and a memory of a computer connected to the DVD driver, so when application programs that require much information are concurrently driven they may malfunction or crash the computer, which makes it almost impossible to concurrently drive multiple application programs on a single computer.

### SUMMARY OF THE INVENTION

It is an object of the present invention to provide a complex computer system for controlling sound and graphic data of at least two respective electronic instruments and reducing computer load caused by data processing.

In one aspect of the present invention, a complex system comprises: a plurality of graphic data output units for displaying graphic data to a user; a plurality of graphic data processors for analyzing the graphic data, and converting them into a data format desired by the graphic data output units; a first graphic data controller for receiving the graphic data, and assigning a graphic data processor for processing the graphic data according to a control signal so that the corresponding graphic data may be input to the assigned graphic data processor; a control signal input unit for generating the control signal for assigning one of the graphic data processors for processing the graphic data; an application program storage unit for storing application programs; and a central processing unit (CPU) for driving the application programs, receiving graphic data generated at this time and the control from the control signal input unit, and outputting them to the graphic data controller.

The complex system further comprises: a plurality of sound data output units for providing sound data to a user; a plurality of sound data processors for analyzing the sound data and converting them into a data format desired by the sound data output units; and a sound data controller for receiving the sound data, performing a switching operation according to a control signal, assigning a sound data processor for processing the sound data so that the corresponding sound data may be input to the assigned sound data processor, and the CPU outputs the control signal output by the control signal input unit and the sound data generated while driving the application program to the sound data controller.

The complex system further comprises an instrument unit for generating a plurality of graphic data; and a second graphic data controller for setting the graphic data output unit for outputting the graphic data output by the instrument unit according to the control signal.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a complex system according to a preferred embodiment of the present invention; and

FIG. 2 shows a graphic data controller according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the; drawings and description are to be regarded as illustrative in nature, and not restrictive.

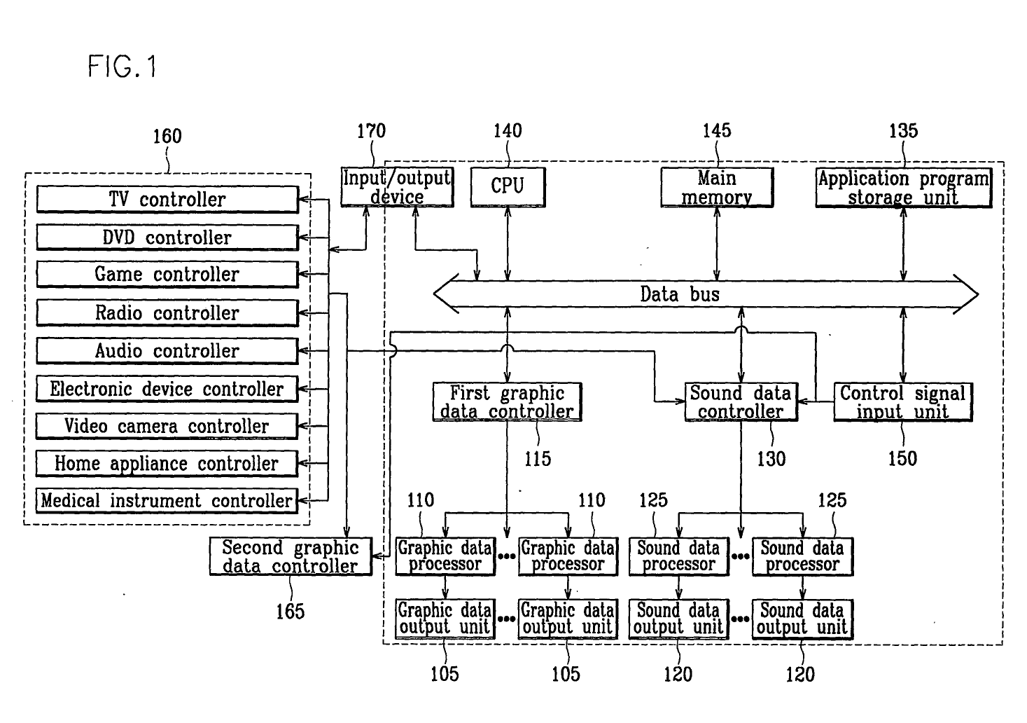

FIG. 1 shows a block diagram of a complex computer system according to a preferred embodiment of the present invention.

As shown, the complex computer system comprises: a multiple output computer that includes a plurality of graphic data output units 105; a plurality of graphic data processors 110; a first graphic data controller 115, a plurality of sound data output units 120; a plurality of sound data processors 125; a sound data controller 130; an application program storage unit 135, a CPU 140, a main memory 145; a control signal input unit 150; an instrument unit 160 for generating sound and graphic data output by various electronic devices; a second graphic data controller 165; and an input and output device 170.

In this instance, respective instruments' controllers included in the instrument unit 160 process data before the graphic data processors 110 and the sound data processors 125 process the data. The instrument unit 160 comprises a television controller, a DVD controller, a game controller, a radio controller, an audio controller, an electronic device controller, a video camera controller, a home appliance controller and a medical instrument controller. For example, the DVD controller reads information from a DVD ROM, and processes the information before the information is input to the graphic data processors 110 and the sound data processors 125.

The graphic data output units 105 such as monitors display graphic data to users.

The graphic data processors 110 such as graphic cards analyze graphic data such as gray information and RGB information and convert them into a data format to be output by the graphic data output units 105.

The first graphic data controller 115 receives graphic data generated while the multiple output computer is executing a plurality of application programs, performs a switching operation according to a control signal, and assigns a graphic data processor 110 for processing the graphic data so that the corresponding graphic data may be input to the assigned graphic data processor 110.

The sound data output units 120, such as speakers, output sound to the users.

The sound data processors 125, such as sound cards, analyze sound data and convert them into a data format that fits to be output by the sound data output units 120.

The sound data controller 130 receives sound data from various devices, and switches the sound data processor 125 for processing the sound data according to a control signal so that the corresponding sound data may be input to the assigned sound data output unit 120.

The application program storage unit 135 stores application programs such as word processors or spreadsheets.

The control signal input unit 150 includes a mouse, a keyboard and a keypad, and generates control signals for assigning whether the graphic data or the sound data input by at least one device are output by the graphic data output unit 105 or the sound data output unit 120;

The CPU 140 controls whole operations of the computer, drives a plurality of application programs to operate them according to the user's intention, outputs the sound data and graphic data generated in this instance to the graphic data controller 115 and the sound data controller 130, receives the control signal generated by the control signal input unit 150, and assigns which graphic data processor 110 and sound data processor 125 among the plural graphic and sound data processors are to process the graphic data controller 115 and the sound data controller 130 data.

The main memory 145 temporarily stores data generated when the CPU drives application programs.

The controllers of the various instruments included in the instrument unit 160 generate the sound and graphic data to be processed through the graphic data processor 110 and the sound data processor 125 assigned by the graphic data controller 115 and the sound data controller 130 according to the control signals of the control signal input unit 150, and outputs them to the second graphic data controller 165.

The second graphic data controller 165 assigns a graphic data output unit 105 for outputting a plurality of analog graphic data output by the instrument unit 160.

The input and output device 170, an input/output interface, transmits digital data of external devices such as digital cameras to the multiple output computer so that the multiple output computer processes the digital data to output them to one of the at least two graphic data output units 105. In this instance, the assignment of the graphic data output unit 105 is performed through the first graphic data controller 115, the graphic data processors 110 and the graphic data output units 105.

An operation of the complex system according to the preferred embodiment of the present invention will now be described in detail.

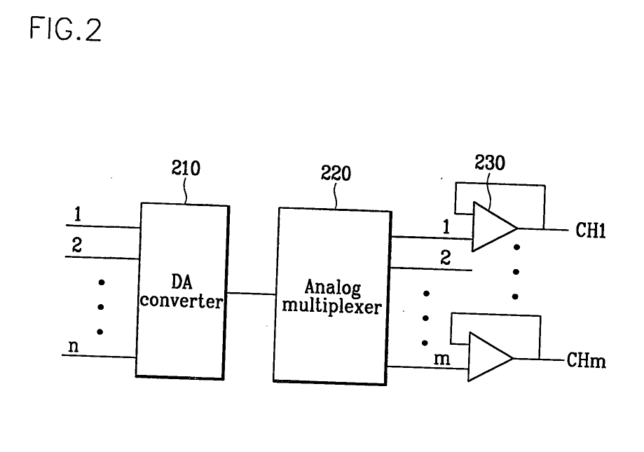

FIG. 2 shows a circuit diagram of the first graphic data controller 1 15.

As shown, the first graphic data controller 115 is a switching device, and when a digital/analog converter 210 receives n-bit control signals from the control signal input unit 150 or a data bus, the digital/analog converter 210 converts the digital signals into analog signals and outputs them to an analog multiplexer 220. When receiving the analog signals, the analog multiplexer 220 outputs signals to an m-number of comparators 230 according to the input analog signals, and the m-number of comparators 230 compare the signals with a reference voltage and determine channel on/off states.

When the user manipulates the control signal input unit 150 to output to the second graphic data controller 165 and the sound data controller 130 control signals for assigning a graphic data output unit 105 and a sound data processor 125 for respectively processing the graphic data and the sound data output by the instrument unit 160, the second graphic data controller 165 switches the graphic and sound data to be input to the assigned graphic data output unit 105 and the sound data processor 125.

Also, when the user manipulates the control signal input unit 150 to output control signals for assigning a graphic data processor 110 and a sound data processor 125 for processing the graphic and sound data of driven application programs, the CPU 140 outputs the control signals to the first graphic data controller 115 and the sound data controller 130. When receiving the control signals, the first graphic data controller 115 and the sound data controller 130 perform a switching operation so that the graphic and sound data generated while a specific application program is being driven may be input to the graphic data processor 110 and the sound data processor 125 assigned by the user.

In this instance, a digital camera (not illustrated) is connected to the input and output device 170 so that the digital data of the digital camera may be processed by the multiple output computer.

Through the above described operation, the graphic and sound data output by a plurality of electronic instruments and those generated while driving multiple application programs can be processed by assignment of the graphic data output unit 105 and the sound data output unit 120. Also, the bottleneck problem generated when the CPU and the main memory 140 of the conventional computer process huge amounts of data created by a DVD player can be prevented.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

For example, the instrument unit 160 and the multiple output computer can be arranged on a single mold. Also, the graphic data controller can be implemented in hardwired and software manners.

Therefore, at least two graphic and sound data processors can process the graphic and sound data generated by at least two electronic devices and the application program, and a heavy load provided to the CPU and the main memory of a computer can be prevented.

What is claimed is:

1. A complex system comprising:
a plurality of graphic data output units for displaying graphic data to a user;
a plurality of graphic data processors for analyzing the graphic data, and converting them into a data format desired by the graphic data output units;
a first graphic data controller for receiving the graphic data, and assigning a graphic data processor for processing the graphic data according to a control signal so that the corresponding graphic data may be input to the assigned graphic data processor;
a control signal input unit for generating the control signal for assigning one of the graphic data processors for processing the graphic data;
an application program storage unit for storing application programs; and
a central processing unit (CPU) for driving the application programs, receiving graphic data generated at this time and the control signal from the control signal input unit, and outputting them to the graphic data controller.

2. The complex system of claim 1, wherein the first graphic data controller performs a switching operation according to the control signal and assigns the graphic data processor.

3. The complex system of claim 1, wherein the complex system further comprises: a plurality of sound data output units for providing sound data to a user; a plurality of sound data processors for analyzing the sound data and converting them into a data format desired by the sound data output units; and a sound data controller for receiving the sound data, performing a switching operation according to a control signal, assigning a sound data processor for processing the sound data so that the corresponding sound data may be input to the assigned sound data processor, and the CPU outputs the control signal output by the control signal input unit and the sound data generated while driving the application program to the sound data controller.

4. The complex system of claim 3, wherein the sound data controller performs a switching operation according to the control signal and assigns the sound data processor.

5. The complex system of claim 1, wherein the complex system further comprises an instrument unit for generating a plurality of graphic data; and a second graphic data controller for setting the graphic data output unit for outputting the graphic data output by the instrument unit according to the control signal.

6. The complex system of claim 3, wherein the complex system further comprises an instrument unit for generating sound data to be processed through the sound data processor assigned by the sound data controller, and outputting them to the sound data controller.

7. The complex system of claim 5 or 6, wherein the instrument unit comprises a television controller, a digital video disk (DVD) controller, a game controller, a radio controller, an audio controller, an electronic device controller, a video camera controller, a home appliance controller and a medical instrument controller, for outputting graphic data to be output to the graphic data output unit selected by the second graphic data controller and outputting sound data to be processed by the sound data processor assigned by the sound data controller.
